(19) United States
(12) Patent Application Publication
(10) Pub. No.: US 2007/0035668 A1
(43) Pub. Date: Feb. 15, 2007

(54) Method of routing an audio/video signal from a television's internal tuner to a remote device

(75) Inventor: Thomas Ulrich Swidler, San Jose, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 11/202,782

(22) Filed: Aug. 11, 2005

(51) Int. Cl. H04N 7/00; H04N 5/60

(52) U.S. Cl. 348/738; 348/552

(57) ABSTRACT

A method of and apparatus for directly routing the output an internal television tuner allowing for the use of a decoded audio-video data signal by a remote device. The method of and apparatus for routing the output signal of a television's internal tuner allowing for direct use of a decoded audio-video data signal comprises receiving a digital broadcast signal at a television, decoding the broadcast signal with one or more digital tuners within the television to generate a decoded audio-video data signal, and routing the decoded audio-video data signal from the tuner to an output port of the television, wherein the output port is configured to communicably couple to a remote device, such as a recording device or a remote display screen. The audio-video data signal comprises an audio-video signal and control data. Preferably, the decoded audio-video data is in a digital format. Alternatively, the decoded audio-video data is in an analog format. The television sends the audio-video data signal to a remote device. The remote device receives the decoded audio-video data signal directly from the tuner as a decoded input signal. The decoded audio-video data signal received by the remote device is immediately usable and does not require further processing before recording or displaying on the remote device.

### FIELD OF THE INVENTION

The present invention relates to the field of televisions. More specifically, the present invention relates to the field of televisions having internal tuners from which a user might desire to record a decoded audio-video signal or pipe a decoded audio-video signal to another device.

### BACKGROUND OF THE INVENTION

Currently, there are two standards in use for television broadcasts “over the air” and cable broadcasts. An analog standard has been the predominant standard for years and was developed by the National Television System Committee (NTSC). A digital standard has emerged and was developed by the Advanced Television System Committee (ATSC). Over the air broadcast means that the television signal is received by the television's tuner through an antenna which picks up the RF (radio frequency) signal. With a conventional cable broadcast, the RF signal is received directly from a coaxial cable. A NTSC tuner is unable to process digital signals, and an ATSC tuner is unable to process analog signals. The higher quality of the digital format makes ATSC the preferred standard, but currently major network television broadcasts both the NTSC and the ATSC standards. However, the Federal Communications Commission (FCC) is in the process of phasing out the NTSC standard by requiring certain television sets to contain at least one ATSC tuner so that all televisions eventually will be compatible with the ATSC digital format.

Television viewers who use an ATSC compatible television are able to watch television programming with higher quality picture and sound. The problem for these ATSC television users arises when they want to record a television program. Recording devices on the market have an internal tuner, but the recording device typically only contains one NTSC standard tuner. Therefore, the high quality television and sound which the viewer sees and hears at the television set is not the same audio and video that is being simultaneously recorded on the recording device. The audio and video recorded on the device is of inferior quality compared to the viewable image and sound on an ATSC-compatible television.

A block diagram of an early television and recording device is illustrated in FIG. 1A. The cable or over-the-air analog signal is received through a connection 30 from the source outlet 10 and directed to the television 100. The tuner 110 processes the analog signal so that a channel selected by the user is viewable on the screen 120. The tuner 110 is only capable of processing one channel for viewing at any given time. The connection 50 is split into a connection 60 and a connection 70; identical signals are routed through the connections 60 and 70. The viewable analog signals are directed to the screen 120 through the connection 60. In such a system, if the user desires to record a program, the viewable analog signals are directed to the recording device 200 through the connection 70. Later when the user desires to watch the recorded program, the recording device 200 directs the viewable analog signals to the screen 120 through the connection 80. Since the recording device 200 does not have a dedicated tuner, the user is unable to watch a television program while simultaneously recording another program. Further, the recording is in an analog format.

Now referring to FIG. 1B, to allow a user to simultaneously watch one television program while simultaneously recording a different television program, recording devices were manufactured with a dedicated tuner 211. This system splits the signal from the cable or antenna 10 into two connections, the connection 31 and the connection 71. The signals available at the connections 31 and 71 are identical and unprocessed. The connection 31 provides input to the television's tuner 111. The television tuner 111 is traditionally a NTSC tuner but more typically today, the television tuner 111 is an ATSC tuner. The television tuner 111 processes the signal according to the channel selected by the user and directs the viewable signal to the screen 121 through the connection 61. The connection 71 provides input to the recording device's tuner 211 which is generally a NTSC tuner. The cost of including an ATSC tuner in the recording device 201 is prohibitively high. The recording device tuner 211 processes the signal according to the same or different channel selected by the user. The channel viewed and the channel recorded are tuned by two independent tuners. When the user desires to watch the recorded program, the recording device 201 directs a viewable signal to the screen 121 through the connection 81. Since the recording device tuner 211 is a NTSC tuner, the viewable signal directed through the connection 81 to the screen 121 is analog.

The state of the art is illustrated in FIG. 1C. The configuration is largely similar to that of FIG. 1B. The major difference is that the television 102 contains two tuners 112 and 113. Many televisions on the market today have two tuners for picture-in-picture functions and other various functions. Input to the television, provided by the connection 32, is further split into the connection 37 and the connection 38 inside the television. The connections 37 and 38 serve as input to the television tuners 112 and 113, respectively. The tuners 112 and 113 process the signal and direct a decoded audio-video signal through the connections 62 and 63, respectively, to the screen 122 and a picture-in-picture screen segment 123, respectively. Again when replaying the recording, since the recording device tuner 212 is a NTSC tuner, the audio-video signal directed by the connection 82 to the screen 122 is analog.

Currently, there are several solutions to the problem of recording digital over-the-air broadcasts. One solution is that a second tuner conforming with the ATSC standard is added to the recording device. However, adding a second tuner to a recording device is prohibitively expensive for the manufacturers and the consumers since tuner components are expensive and recording devices are sold at a low profit margin. Another solution would be to replace the NTSC standard tuner with an ATSC standard tuner in all new recording devices. The first disadvantage to this solution is that one tuner is still dedicated to recording only. This is an inefficient use of resources, especially given the added expense of tuner components. A second disadvantage of this solution is that during the FCC transition period, smaller television stations that only broadcast a NTSC standard signal would be unrecordable by the ATSC-only recording device.

### SUMMARY OF THE INVENTION

A method of and apparatus for routing the output signal of a television's internal tuner allows for direct use of a decoded audio-video signal by a remote device, such as a recording device or a remote display screen. A method of routing the output signal of a television's internal tuner allowing for direct use of a decoded audio-video signal comprises receiving a digital broadcast signal at a television, decoding the broadcast signal with at least one tuner within the television to generate decoded audio-video data, and routing the decoded audio-video data from the tuner to an output port of the television, wherein the output port is configured to communicably couple to a remote device. The audio-video data comprises an audio-video television signal. In some embodiments, the audio-video data comprises control data. In some embodiments, the audio-video data comprises programming information. Additionally, control data is routed to the output port. Preferably, the decoded audio-video data signal is in a digital format. Alternatively, the decoded audio-video data signal is in an analog format. The television sends the audio-video data to a remote device which is preferably a recording device, or alternatively is a remote display screen. The remote device receives the decoded audio-video data directly from the tuner as a decoded input signal.

In another aspect of the invention, a method of providing a directly recordable output from a television's tuner comprises receiving a digital broadcast signal at a television, decoding the broadcast signal with at least one tuner within the television to generate a decoded audio-video signal, routing the decoded audio-video signal from the television tuner to an output port, and further routing the decoded audio-video signal to a remote device. In one embodiment, control data is routed to a remote device. The remote device receives a decoded audio-video signal which is taken as input to the remote device. In another embodiment, the present invention discloses receiving control data from a remote device at the television. Preferably, the remote device is a recording device, or alternatively is a remote display screen.

In another aspect of the invention, a television for receiving and routing an audio-video signal is disclosed. The television comprises a tuner coupled to receive a digital broadcast signal and to generate a decoded audio-video signal and an output port coupled to the tuner wherein the decoded audio-video signal is directly routed to the output port. The television includes at least one tuner. At least one of the tuners is internal to the television. In one embodiment, the television further comprises an input port coupled to the television for receiving control data. In another embodiment, the television further comprises a recording device wherein the output port sends data to the recording device. The recording device receives a decoded audio-video signal which is the decoded audio-video output signal from the tuner. Preferably, the recording device also has an output data port for sending control data to the television.

In yet another aspect of the invention, a display apparatus for receiving and routing an audio-video signal is disclosed. The display apparatus comprises a display screen, a tuner coupled to receive a digital broadcast signal and to generate a decoded audio-video signal, and an output port coupled to the tuner wherein the decoded audio-video signal is directly routed to the output port for use by a remote device. In one embodiment, the display apparatus has multiple tuners. At least one of the tuners is internal. Preferably, the decoded audio-video data signal is in a digital format. Alternatively, the decoded audio-video data signal is in an analog format. In one embodiment, the display apparatus further comprises an input port coupled to the display apparatus for receiving control data. In another embodiment, the display apparatus further comprises a recording device wherein the output port sends data to the recording device. The recording device is capable of receiving a decoded audio-video signal directly from the tuner. The recording device includes an output data port for sending control data to the display apparatus.

The present invention discloses a recording device, which comprises a recording device input port configured to receive a decoded digital audio-video signal from a tuner of a television and recording media coupled to the recording device input port to receive and record a selected portion of the decoded digital audio-video signal. The recording device further comprises an output port wherein the recording device is capable of communicating with the television. The recording device input port receives control data. In one embodiment, the recording device controls certain function of the television. In another embodiment, the television controls certain function of the recording device.

A system for routing an audio-video data signal is disclosed in another aspect of the present invention. The system comprises a television and a recording device. The television includes a tuner coupled to receive a digital broadcast signal and to generate a decoded audio-video data signal and an output port coupled to the tuner wherein the decoded audio-video signal is directly routed to the output port. The recording device includes an input port configured to receive a decoded audio-video data signal from the television though an output port of the television and recording media coupled to the input port to receive and record a selected portion of the decoded audio-video data signal. Preferably, the decoded audio-video data signal comprises a television signal. The decoded audio-video data signal comprises control data and programming information. Additionally, control data is routed to the output port. In one embodiment, the television has multiple tuners. There is at least one tuner that is internal to the television. Preferably, the decoded audio-video data signal is in a digital format. Alternatively, the decoded audio-video data signal is in an analog format. In another embodiment of the present invention, the television includes an input for receiving control data from the recording device which has an input for receiving a decoded audio-video signal. Preferably, the television data output port sends control data to the recording device and the recording device has an output data port for sending control data to the television. The recording device controls certain functions of the television. The television controls certain functions of the recording device.

Other features and advantages of the present invention will become apparent after reviewing the detailed description of the preferred embodiments set forth below.

### BRIEF DESCRIPTION OF THE DRAWINGS

FIG. 1A illustrates an early state of the prior art.

FIG. 1B illustrates an evolution of the prior art.

FIG. 1C illustrates the state of the art.

FIG. 2A illustrates a functional block diagram of an exemplary connection of a television and a remote device in accordance with the present invention.

FIG. 2B illustrates a functional block diagram of an exemplary connection of a television and a recording device in accordance with the present invention.

FIG. 2C illustrates a functional block diagram of an exemplary connection of a television and a remote display screen in accordance with the present invention.

FIG. 3 illustrates a functional block diagram of the system disclosed by the present invention including a television and a recording device.

FIG. 4A illustrates a flow chart of the method of the present invention.

FIG. 4B illustrates a flow chart of an alternative method of the present invention.

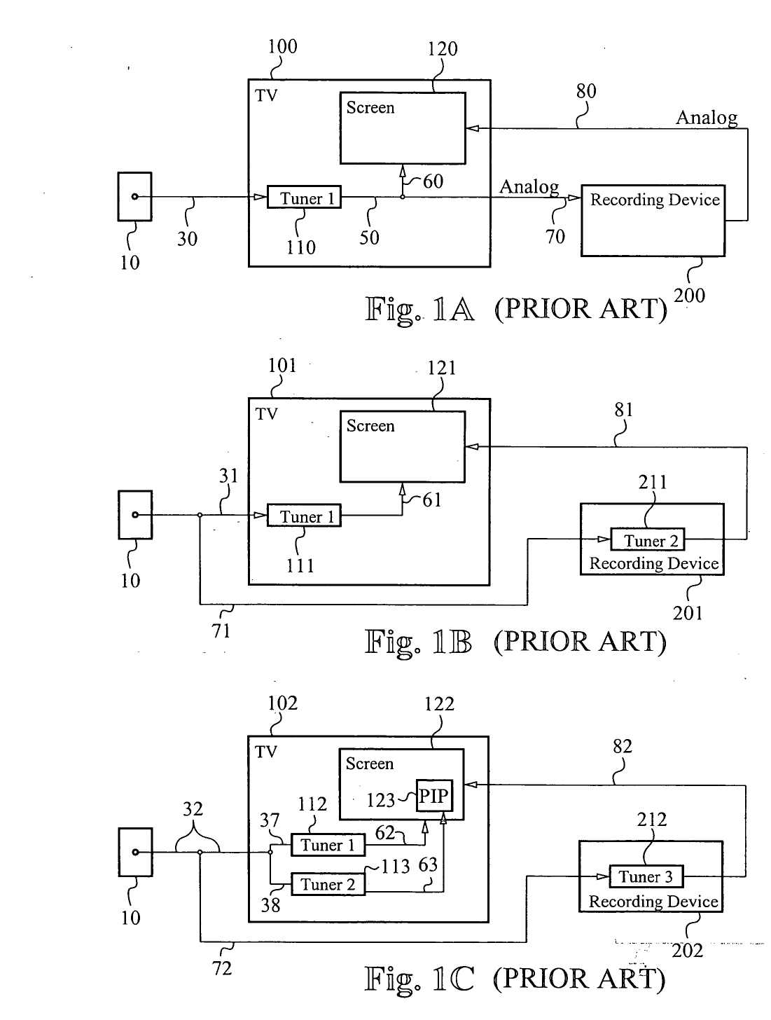

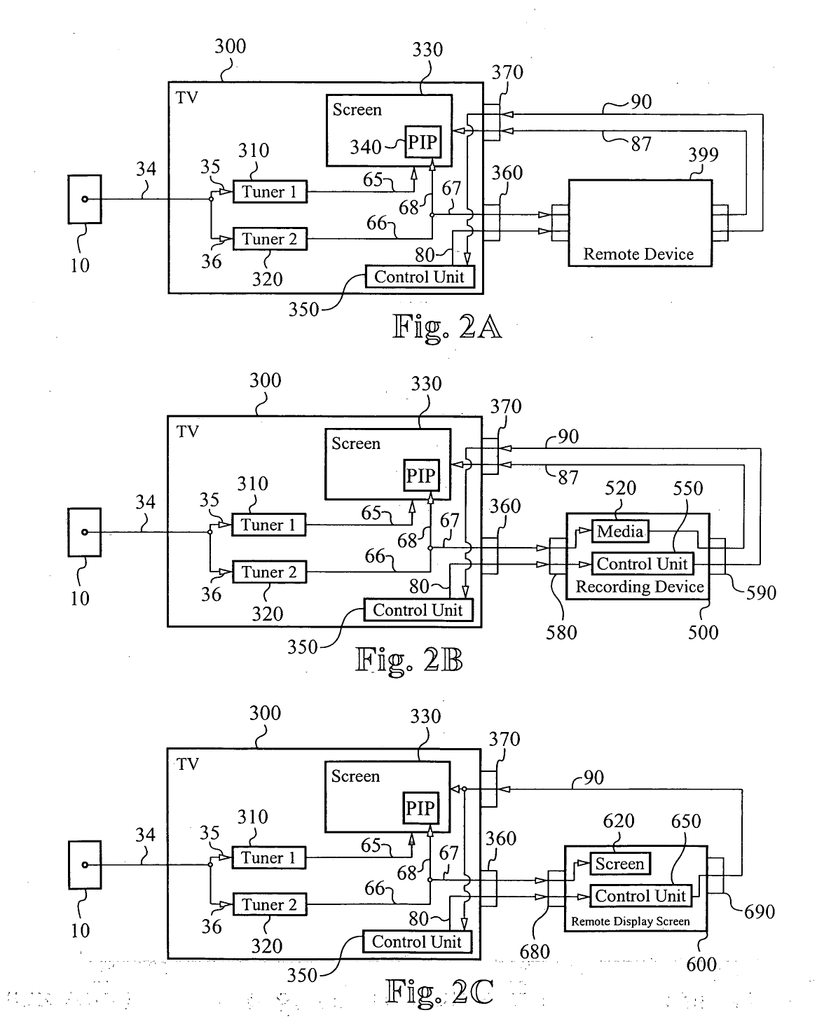

### DETAILED DESCRIPTION OF A PREFERRED EMBODIMENT

Reference will now be made in detail to the preferred and alternative embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it should be noted that the present invention may be practiced without these specific details. In other instances, well known methods, procedures and components have not been described in detail as not to unnecessarily obscure aspects of the present invention.

A method of and apparatus for routing the output signal of a television's internal tuner allowing for direct use of the decoded audio-video signal by a remote device, such as a recording device or a remote display screen, is disclosed by the current invention. In accordance with the present invention, FIG. 2A illustrates a television for receiving and routing an audio-video signal for direct use by a remote device. The television 300 is coupled to receive a digital broadcast signal through a connection 34. The digital broadcast signal is available through standard methods from a cable or antenna outlet 10. The connection 34 is split into the connections 35 and 36. The television 300 comprises a first tuner 310 coupled to receive a digital broadcast signal through the connection 35 and to generate a decoded audio-video data signal. Preferably, the television 300 comprises a second tuner 320 coupled to receive a digital broadcast signal through the connection 36 and to generate a decoded audio-video data signal. The decoded audio-video data signal from the first tuner 310 is routed to the television screen 330 through the connection 65 where the audio-video signal is displayed. The output of the tuner 320 is a decoded audio-video data signal routed by the connection 66. The connection 66 is split into a connection 67 and a connection 68; the connections 67 and 68 route identical signals. Preferably, the decoded audio-video data signal from the second tuner 320 is routed through the connection 67 directly to an output port 360 and through the connection 68 to the television picture-in-picture screen segment 340. Preferably, both tuners are compatible with a digital standard. Alternatively, one or more tuners is compatible with a digital standard. Preferably, the tuners 310 and 320 take a digital broadcast signal as input through the connections 35 and 36 and output a digital audio-video signal. Alternatively, a digital tuner contains a digital-to-analog converter to output an analog audio-video signal. Decoding the digital broadcast signal occurs within the tuners 310 and 320 using conventional methods. The output port 360 is configured to communicably couple to a remote device 399 such as a recording device or a remote display screen.

Alternatively, the television has one digital tuner and the output of that one tuner is split into multiple connections wherein one connection routes a decoded audio-video signal to the television screen and a second connection routes the same decoded audio-video signal to an output port configured to communicably couple to a remote device. However, this embodiment is not preferred since it does not enable the viewer to watch one program on the television screen and simultaneously record a different television program with the recording device.

In some embodiments, the remote device 399 directly utilizes the output of the second television tuner 320 without any additional processing from the connection 67. Alternatively, the remote device 399 directly utilizes the output of the first tuner 310 without any additional processing when the connections to the first tuner 310 and the second tuner 320 are interchanged. The remote device 399 is capable of receiving, recording, displaying or otherwise utilizing the decoded audio-video signal, which the user is capable of viewing on the television screen 330 or the picture-in-picture screen segment 340. The configuration of the present invention allows this because the television screen 330 and the output port 360 both receive the same audio-video digital signal through the connection 66 split into the connections 67 and 68. Therefore, when the viewer watches a high-quality, digital image on the screen 330, a communicably coupled device 399 is capable of receiving, recording and/or displaying the same decoded digital signal displayed on the television screen 330.

Since the output port 360 provides a decoded audio-video signal, a communicably coupled device need not have a dedicated tuner in order to receive, display, record or otherwise utilize the decoded audio-video signal routed via the connection 67. This minimizes production costs for the manufacturer and purchase costs for the consumer. The use of the television's internal tuner is also an efficient use of hardware resources. Preferably, the television 300 contains multiple tuners 310 and 320. Alternatively, the television 300 contains at least one tuner. One or more of the tuners is internal to the television.

In one embodiment, the television further comprises a control unit 350 which sends control data to the communicably connected remote device 399 through the connection 80. Control data includes instructions that dictate functions including turning the remote device on and turning the remote device off. Control data includes programming information in some embodiments. In another embodiment, the television 300 further comprises an input port 370 coupled to the television 300 for receiving control data via the connection 90. The control data is routed from the input port 370 the control unit 350. The control unit 350 receives control data from a remote device 399 which includes instructions which dictate various functions including: turning the television on, turning the television off, and selecting the tuner channel.

The remote device 399 is any number of devices including a recording device or a remote display screen. In one embodiment, the television is communicably coupled to a remote recording device 500 (see FIG. 2B) wherein audio-video data is sent to the recording device 500 through the connection 67. In another embodiment, the television 300 is communicably coupled to a remote display screen 600 (see FIG. 2C) wherein audio-video data is sent to the remote display screen 600 through the connection 67. Preferably, the remote device 399 is capable of routing data signals back to the television 300 through the connections 87 and 90. The connections which communicably couple the television 300 to the remote device 399 (the connections 67, 80, 87 and 90) are physical connections, such as cables or wires, in one embodiment. In an alternative embodiment, the connections comprise an appropriate wireless format or protocol where signals are routed wirelessly.

In accordance with the present invention, FIG. 2B illustrates a recording device for directly recording an audio-video output from a television's internal digital tuner. The recording device 500 comprises an input port 580 configured to communicably couple to the output port of a television and receive a decoded digital audio-video signal from a tuner of the television, recording media 520 coupled to the input port 580 to record a selected portion of the decoded audio-video signal, a control unit 550 coupled to receive and dispatch control data and an output port 590 configured to communicably couple to the input port of a television. The recording device input port 580 receives the decoded audio-video signal via the connection 67 which connects the output port of a television to the recording device input port 580. Preferably, the recording device input port 580 also receives control data via the connection 80 from the output port of a television. The recording device output port 590 dispatches control data to an input port of a television through the connection 90 and routes a digitally recorded audio-video signal through the connection 87 upon replaying the recording.

The recording device input port 580 receives a decoded audio-video signal via the connection 67, and the decoded audio-video signal is recorded using conventional means onto the recording media 520. Preferably, the audio-video signal is in a digital format. Alternatively, the audio-video signal is an analog signal converted from a digital signal within the tuner. The recording media 520 is capable of being replayed. When the user desires to replay the recording, the recording device 500 sends audio-video signals via the connection 87 to a television input port. In the preferred embodiment, the recorded audio and video displayed by the television is digital and has the same high quality that the user would view and hear in the event that he or she watched the recorded segment as it was received and decoded at the initial broadcast.

A control unit 550 further dispatches control data via the connection 90 to the television input port. The control data dispatched by the recording device control unit 550 to the television input port via the connection 90 comprises instructions and programming information. Control data dispatched from the recording device control unit 550 control functions such as: turning the television on, turning the television off, setting a television a timer, and selecting a television a channel. The control unit 550 also processes the control data received from the television via the connection 80. The television control data includes instructions and programming information which the recording device uses to perform functions including: turning the recording device on, turning the recording device off, start recording, stop recording, recording for a predetermined length of time and recording certain genres based on the programming information.

In the preferred embodiment of the present invention, the recording device 500 and the television 300 are communicably coupled. The television output port 360 is communicably coupled to the recording device input port 580 and the recording device output port 590 is communicably coupled to the television input port 370. The recording device 500 receives a decoded audio-video data signal via the connection 67 which is the decoded output from tuner 320 of the television. Preferably, the audio-video data comprises an audio-video signal and control data. Alternatively, the recording device 500 receives a decoded audio-video signal which is the decoded output from the tuner 320 of the television via the connection 67 and further receives control data from the television control unit 350 via the connection 80.

The recording device 500 records the signal that is directly outputted from the television 300; more specifically, the recording device 500 records the decoded audio-video data signal from the connection 67. The recording device 500 utilizes conventional methods for recording the desired program onto the recording media 520 and for replaying the program from the recorded media 520. Preferably, the recording device 500 also has a recording device output data port 590 for sending control data to the television via the connection 90. Also preferably, the television input port 370 is configured to receive control data via connection 90 from the recording device 500.

The recording device output port 590 dispatches control data to the television input port 370 to control various functions. The control data is routed from the television input port 370 to the television control unit 350 which processes the instructions. In yet another embodiment, the recording device input port 580 receives control data 90. In one embodiment, the recording device 500 controls certain function of a television 300. In another embodiment, a television 300 controls certain functions of the recording device 500. When the user desires, the recording media 520 is capable of being replayed by conventional means. The recorded program is routed to the output port 590 wherein the output port 590 is configured to communicably couple to the television input port 370. The recording device output port 590 and the television input port 370 are coupled with a connection 87. Preferably, the signal routed upon replay via the connection 87 is a digital audio-video signal.

In accordance with the present invention, FIG. 2C illustrates a remote display screen for directly displaying an audio-video output signal from a television's internal digital tuner. The remote display screen 600 comprises an input port 680 communicably coupled to receive a decoded digital audio-video signal, a viewable screen 620 coupled to display the decoded digital audio-video signal, a control unit 650 coupled to receive, process and dispatch control data and an output port 690 configured to route control data. The remote display screen 600 is configured to communicably couple to a television at the remote display input screen port 680 and the remote display screen output port 690.

The audio-video signal generated at the internal television tuner is piped to the remote display screen 680. The remote display screen input port 680 receives a decoded digital audio-video signal via the connection 67, and the decoded digital audio-video signal is displayed using conventional means onto the viewable screen 620. The viewable screen 620 is capable of displaying high-quality, digital audio and video without use of a dedicated tuner. The recorded audio and video displayed by the viewable screen 620 has the same high quality as the images and sounds that are displayed on a source device with a dedicated tuner.

A control unit 650 dispatches control data via the connection 90 to the television input port. The control data dispatched by the recording device control unit 650 to the television input port via the connection 90 comprises instructions to the television. Control data instructions issued from the remote display screen control unit 650 control specific functions, including: turning the television on, turning the television off, setting a television a timer, and selecting a television channel. The input port 680 further receives control data via the connection 80. The control unit 650 processes the control data received from the television. The television control data includes instructions and programming information which the recording device uses to perform various functions including: turning the remote display screen on, turning the remote display screen off, start displaying, stop displaying and display for a predetermined length of time.

In the preferred embodiment of the present invention, the remote display screen 600 and the television 300 are communicably coupled. The television output port 360 is communicably coupled to the remote display screen input port 680 and the remote display screen output port 690 is communicably coupled to the television input port 370. The remote display screen 600 receives a decoded audio-video data signal via the connection 67 which is the decoded output from tuner 320 of the television. Preferably, the audio-video data comprises an audio-video signal and control data including instructions and programming information. Alternatively, the remote display screen 600 receives a decoded audio-video signal which is the decoded output from tuner 320 of the television via 67 and further receives control data from the television control unit 350 via the connection 80.

The remote display screen 600 displays the signal that is directly outputted from the television 300; more specifically, the remote display screen 600 displays the decoded audio-video data signal from the connection 67. The same high-quality, digital image is capable of being displayed on both the remote display screen 600 and the television 300. The remote display screen 600 utilizes conventional methods for displaying the audio-video on the viewable screen 620. Preferably, the remote display screen 600 also has a remote display screen output port 690 for sending control data to the television via the connection 90. Also preferably, the television input port 370 is configured to receive control data via the connection 90 from the remote display screen 600.

Through the connection 90, the remote display screen output port 690 sends control data to the television input port 370 including instructions such as: turning television on, turning television off, setting a timer and selection of tuner channel. The control data is routed from the television input port 370 to the television control unit 350 which processes the instructions. In yet another embodiment, the remote display screen input port 680 receives control data through the connection 90. In one embodiment, the remote display screen 600 controls certain functions of a television 300. In another embodiment, a television 300 controls certain functions of the remote display screen 600.

Alternatively, the television as discussed above is alternatively replaced with an appropriate display apparatus. The display apparatus comprising a viewable screen, one or more internal digital tuners, and an output port for directly routing the decoded audio-video signal from the internal display apparatus tuner. Other components of the display apparatus are largely similar to that of the above discussed television. Further, communication coupling between the display apparatus and remote devices such as recording devices or remote display screens are in substantial compliance with the description above and throughout.

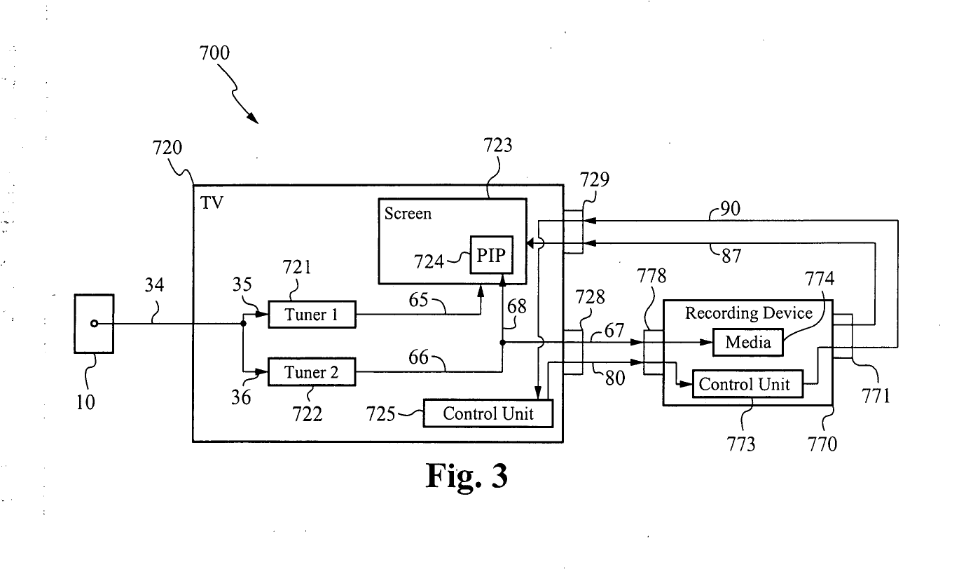

In accordance with the present invention, FIG. 3 illustrates a system for routing an audio-video data signal. In the preferred embodiment, the system 700 comprises a television 720 and a recording device 770. The television 720 includes at least one tuner 721 coupled to receive a digital broadcast signal via the connection 35 and to generate a decoded audio-video data signal. Preferably, the television 720 includes a second tuner 722 coupled to receive a digital broadcast signal via the connection 36 and to generate a decoded audio-video data signal. Decoded audio-video data signals are available through the connections 65 and 66 from the tuners 721 and 722, respectively. The connection 66 is split into the connections 67 and 68 so that an identical audio-video data signal is routed through the connections 67 and 68. An output port 728 is coupled to the tuner 722 with the connection 67 wherein the decoded audio-video data signal is directly routed to the output port 728. Alternatively, an output port 728 is coupled to the tuner 721 wherein the decoded audio-video data signal is directly routed to the output port 728. In one embodiment, the user selects which output from the tuners 721 or 722, is routed to the output port 728. One of the tuners is internal to the television 720. The connections which communicably couple the television 720 to the recording device 770 (the connections 67, 80, 87 and 90) are physical connections, such as cables or wires, in one embodiment. In an alternative embodiment, the connections comprise an appropriate wireless format or protocol where signals are routed wirelessly.

The digital broadcast signal is available via the connection 34 at the television 720 through standard methods from a cable or antenna outlet 10. The tuners 721 and 722 take the digital broadcast signal as input from the connection 34 which is split into the connections 35 and 36. The tuners 721 and 722 decode the digital broadcast signal received via the connections 35 and 36 using conventional methods and output decoded audio-video data signals which are routed through the connections 65 and 66. The decoded audio-video data signal from the tuner 721 is routed to the television screen 723 through the connection 65 and the decoded audio-video signal from the tuner 722 is routed to the picture-in-picture screen segment 724 through the connection 68. Further, the decoded audio-video data signal is routed to the output port 728 by the connection 67. The output port 728 is configured to communicably couple to the recording device 770. Alternatively, the output port 728 is configured to communicably couple to a remote display screen.

The picture-in-picture screen segment 724 and the output port 728 both receive the same decoded digital audio-video data signal from the connections 67 and 68. Therefore, the recording device 770 directly utilizes the output of the television tuner 722 which the user is capable of viewing on the television picture-in-picture screen segment 724. Alternatively, the recording device 770 directly utilizes the output of the television tuner 721 which the user is capable of viewing on the television screen 723. Since the output port 728 provides a decoded audio-video data signal, a communicably coupled device need not have a dedicated tuner in order to receive, display, record or otherwise utilize the decoded audio-video data signal. In one embodiment, the television 720 further comprises an input port 729 coupled to the television 720 for receiving control data via the connection 90. The control data is routed to the television control unit 725.

The television control unit 725 receives instructions from the recording device 770 which dictates various functions including: turning the television on, turning the television off, setting a timer and selection of tuner channel. In one embodiment, the recording device 770 controls a specific tuner within the television 720. The control unit 725 sends instructions and programming information to a communicably connected recording device 770 which dictates various functions including: turning the recording device on, turning the recording device off, start recording, stop recording, record for a predetermined length of time and record certain genres based on the programming information. In one embodiment, the recording device is dormant until a signal is received. Upon receiving an audio-video data signal and the record instruction from the television 720, the recording device 770 turns on and begins to record.

The recording device 770 includes an input port 778 configured to receive a decoded audio-video data signal from the television 720 via the connection 67 though an output port 728 of the television 720 and recording media 774 coupled to the input port 778 to receive and record a selected portion of the decoded audio-video data signal. Preferably, the decoded audio-video data is in a digital format. Alternatively, the decoded audio-video data is in an analog format. Preferably, the decoded audio-video data signals comprise audio-video signals. The decoded audio-video data signals available from the connections 67 and 68 comprise control data including instructions and programming information. Alternatively, control data is dispatched and received in addition to the audio-video signal by the television control unit 725 and the recording device control unit 773.

In some embodiments of the present invention, the television 720 and the recording device 770 dispatch and receive control data in addition to decoded audio-video signals. This communication gives the system disclosed by the present invention a network component which further comprises other intermediary devices. In this embodiment, a plurality of devices utilize the direct output of the television internal tuner 722. Additionally, a plurality of devices dispatch and receive control data related to the use of the decoded audio-video signal from the television tuner 722 output.

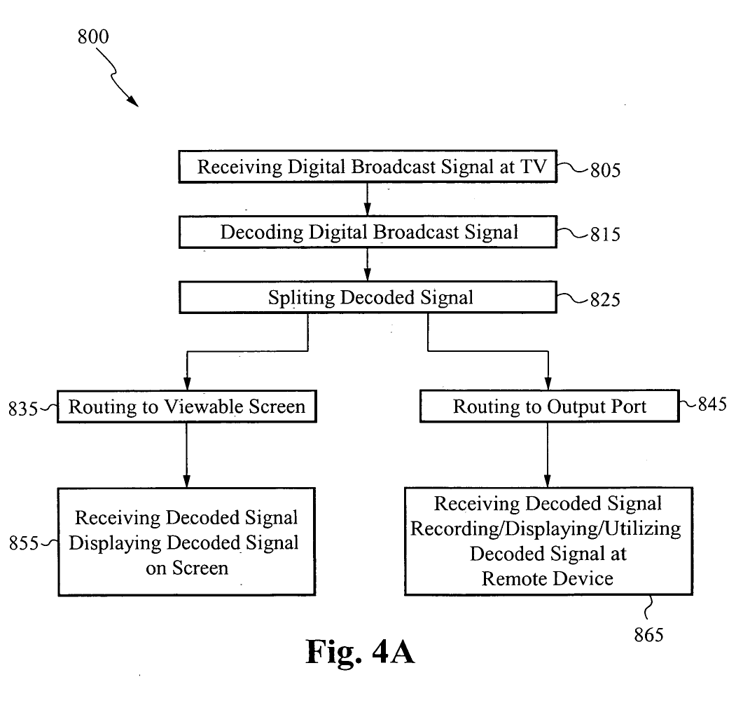

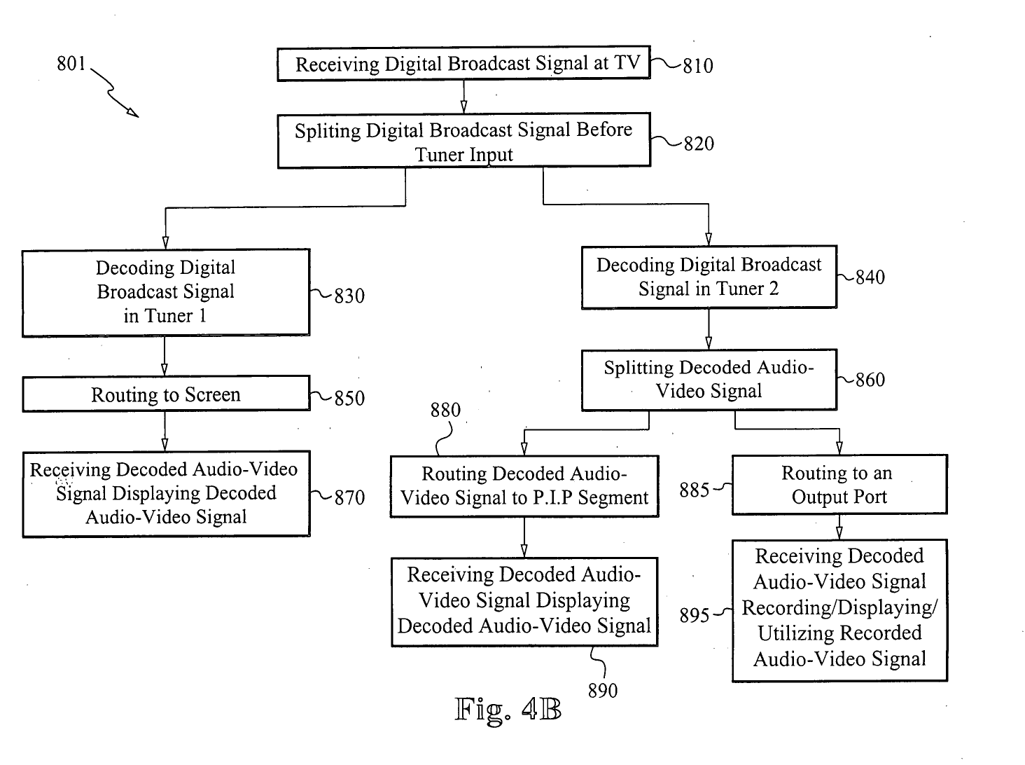

FIG. 4A illustrates a method of routing the output signal of a television's internal tuner allowing for direct use of the decoded signal by a remote device, such as a recording device or a remote display screen. A method 800 of routing the output signal of a television's internal tuner allowing for direct use of the decoded signal comprises receiving a broadcast signal at a television at the step 805, and decoding the broadcast signal with at least one tuner to generate a decoded audio-video data signal at the step 815. The method further comprises splitting the decoded signal so that multiple devices are capable of utilizing the signal at the step 825. At the step 835, one branch of the split signal is routed to the television screen. At the step 855, after the signal is routed to the television screen, the images and sounds comprising the decoded audio-video data signal are received and displayed at the television set. At the step 845, the other branch of the split decoded audio-video data signal is routed from the tuner to an output port of the television. The output port is configured to communicably coupled to a remote device where the audio-video signal is further routed. After the signal is routed to the remote device, then, at the step 865, the signal is received and utilized by the remote device. Preferably, the remote device is a recording device and records the audio-video data signal. Alternatively, the remote device is a remote display screen and displays the routed audio and video.

FIG. 4B illustrates an alternative embodiment of the method of the present invention. The method 801 comprises receiving a broadcast digital signal at a television at the step 810, and splitting the signal inside the television at the step 820. At the step 830, the first branch of the split signal is decoded in a first tuner within the television. At the step 840, a second branch of the split signal is decoded in a second tuner within the television. Decoding the digital broadcast signal generates a decoded audio-video data signal. The method further comprises routing the decoded audio-video data signal from the first tuner to the screen at the step 850. At the step 870, the image and sound is received at the screen and displayed. The method further comprises splitting the decoded audio-video data signal from the second tuner so that multiple devices are capable of utilizing the signal at the step 860. At the step 880, one branch of the split signal is routed to the picture-in-picture screen segment. After the signal is routed to the picture-in-picture screen segment, the images comprising the decoded audio-video data signal are received and displayed on the picture-in-picture screen segment at the step 890. At the step 885, the decoded audio-video data signal is routed from the second tuner to an output port of the television. The output port is configured to be communicably coupled to a remote device. After the signal is routed to the remote device, then, at the step 895, the signal is received and utilized at the remote device. Preferably, the remote device is a recording device and records the audio-video data signal. Alternatively, the remote device is a remote display screen and displays the routed audio and video.

The key to the present invention is that it allows a direct output of a television's internal digital tuner. The present invention has many advantages. First, the direct output of the digital tuner allows a remote device such as a recording device or a remote display screen to utilize the decoded audio-video signal. Therefore, the remote device does not require a dedicated tuner to perform its function. This is especially important because many remote devices, such as a recording device, do not have a digital tuner. Further, the cost of tuner components makes including an digital tuner in the recording device prohibitively expensive since recording devices are sold at a low profit margin.

Another advantage is that when the tuner which the remote device utilizes is included within the television and is not included within the remote device, the user is capable of greater control of the remote device. Since the present invention allows for the television to control various functions of the remote device, the recording device will be less complex to use and to implement in hardware. The recording device, for example, currently requires setting the recording device so that the dedicated analog tuner in the recording device tunes to the appropriate channel at the appropriate time. A user interface is required to implement this feature. Generally, a remote control or similar device is used to navigate through a plethora of menus and options; this remote control is in addition to the television remote control and others. With the present invention, the remote device need not have such an interface as it is directly and more efficiently controlled by using the television controls. The television interface dictates when the television tuner operates and what channel it tunes to. The recording device of the present invention simply awaits a “Start” record instruction at a control data input. Once the recording device receives the instruction, the recording device simply records the already decoded audio-video signal until it receives the instruction “Stop” recoding. Again, since no tuner is required in the recording device of the present invention, the recording device interface is very simple, efficient and cheap to produce. Other functions of the television and recording device are similarly streamlined in the present invention.

Another advantage to some embodiments is that the invention discloses an audio-video network component. The direct output of the television tuner is routed to a plurality of remote devices in other rooms of a building, for example. Audio-video signals do not have significant quality loss when routed over longer distances. Piping the direct output of a television's internal tuner to other devices, such as a remote display screen, is enabled by this invention. There are many remote display screens on the market that do not contain an internal tuner, these devices are capable of utilizing the decoded audio-video signal from the television without an expensive set-top box.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A method comprising:
a. receiving a digital broadcast signal at a television;
b. decoding the digital broadcast signal with at least one tuner within the television to generate decoded audio-video data; and
c. routing the decoded audio-video data from the tuner to an output port of the television, wherein the output port is configured to communicably couple to a remote device.

2. The method of claim 1 wherein the audio-video data comprises control data.

3. The method of claim 1 wherein the audio-video data comprises an audio-video signal.

4. The method of claim 1 wherein the decoded audio-video data is in a digital format.

5. The method of claim 1 wherein the decoded audio-video data is in an analog format.

6. The method of claim 1 wherein the remote device receives the decoded audio-video data as input.

7. The method of claim 1 wherein the remote device is a recording device.

8. The method of claim 1 wherein the remote device is a remote display screen.

9. The method of claim 1 further comprising routing the audio-video data from the output port to a remote display screen.

10. A method of providing a directly recordable audio-video output from a television's tuner, comprising:
a. receiving a digital broadcast signal at a television;
b. decoding the digital broadcast signal with at least one tuner to generate a decoded audio-video signal; and
c. routing the decoded audio-video signal from the television's tuner to a remote device.

11. The method of claim 10 wherein the audio-video signal comprises control data.

12. The method of claim 10 further comprising routing control data to the remote device.

13. The method of claim 10 further comprising receiving control data from the remote device.

14. The method of claim 10 wherein the remote device is a recording device.

15. The method of claim 10 wherein the remote device is a remote display screen.

16. The method of claim 10 further comprising routing the audio-video signal to a remote display screen.

17. A television for routing a signal comprising:
a. a tuner coupled to receive a digital broadcast signal and to generate a decoded signal; and
b. an output port coupled to the tuner wherein the decoded audio-video signal is directly routed to the output port and further wherein the output port is configured to communicably couple to a remote device.

18. The television of claim 17 wherein at least one tuner is internal.

19. The television of claim 17 wherein the television has multiple tuners.

20. The television of claim 17 further comprising an input port on the television for receiving control data.

21. The television of claim 17 further comprising a recording device wherein the televison output port sends data to the remote device.

22. The television of claim 21 wherein the remote device has an output port for sending control data to the television.

23. The television of claim 17 wherein the remote device receives a decoded audio-video input signal.

24. A display apparatus for receiving and routing a signal comprising:
a. a display screen;
b. a tuner coupled to receive a digital broadcast signal and to generate a decoded audio-video signal; and
c. an output port coupled to the tuner wherein the decoded audio-video signal is routed to the output port and further wherein the output port is configured to communicably couple to a remote device.

25. The apparatus of claim 24 wherein at least one tuner is internal.

26. The apparatus of claim 24 wherein the display apparatus has multiple tuners.

27. The apparatus of claim 24 wherein at least one tuner is compatible with an analog standard.

28. The apparatus of claim 24 wherein at least one tuner is compatible with a digital standard.

29. The apparatus of claim 24 further comprising an input port on the display apparatus for receiving control data.

30. The apparatus of claim 24 further comprising a recording device wherein the display apparatus output port sends data to the recording device.

31. The apparatus of claim 30 wherein the recording device has an output data port for sending control data to the display apparatus.

32. The apparatus of claim 24 wherein the recording device receives a decoded audio-video input data signal.

33. A recording device comprising:
a. an input port configured to receive a decoded digital audio-video signal from a tuner of a television; and
b. recording media coupled to the input port to receive and record a selected portion of the decoded digital audio-video signal.

34. The recording device of claim 33 wherein the input port receives control data.

35. The recording device of claim 33 further comprising a recording device output port wherein the recording device is capable of communicating with the television.

36. The recording device of claim 33 wherein the recording device controls certain function of the television.

37. The recording device of claim 33 wherein the television controls certain function of the recording device.

38. A system for routing an audio-video data signal comprising:
a. a television including:
i. a tuner coupled to receive a digital broadcast signal and to generate a decoded audio-video data signal; and
ii. an output port coupled to the tuner wherein the decoded audio-video signal is routed to the output port further wherein the output port is configured to communicably couple to a recording device;
b. a recording device including:
i. an input port configured to receive a decoded audio-video data signal from the television; and
ii. recording media coupled to the input port to receive and record a selected portion of the decoded audio-video data signal.

39. The system of claim 38 wherein the decoded audio-video data signal comprises an audio-video signal.

40. The system of claim 38 wherein the decoded audio-video data signal comprises control data.

41. The system of claim 38 wherein at least one tuner is internal to the television.

42. The system of claim 38 wherein the television has multiple tuners.

43. The system of claim 38 wherein at least one tuner is compatible with an analog standard.

44. The system of claim 38 wherein at least one tuner is compatible with a digital standard.

45. The system of claim 38 further comprising an input port on the television for receiving control data.

46. The system of claim 38 wherein the television output port sends control data to the recording device.

47. The system of claim 38 wherein the recording device has an output port for sending control data to the television.

48. The system of claim 38 wherein the recording device controls certain function of the television.

49. The system of claim 38 wherein the television controls certain function of the recording device.

50. The system of claim 38 further comprising a network component including a plurality of device configured to communicably couple to the output port of the television wherein a decoded audio-video signal is available.

51. The system of claim 38 wherein the recording device controls a specific tuner within a television.

52. The system of claim 38 wherein a user selects which tuner is routed to the output port.
